(19) United States
(12) Patent Application Publication
(10) Pub. No.: US 2003/0150479 A1
(43) Pub. Date: Aug. 14, 2003

(54) Blade cleaner and a method of cleaning blades

(76) Inventor: H. Christopher Morris, Moorestown, NJ (US)

Correspondence Address: Licata & Tyrrell P.C., 66 E. Main Street, Marlton, NJ, 08053, US

(21) Appl. No.: 10/345,449

(22) Filed: Jan. 15, 2003

Related U.S. Application Data
(60) Provisional application No. 60/348,698, filed on Jan. 15, 2002.

(51) Int. Cl. A47L 13/10; B08B 1/00

(52) U.S. Cl. 134/6; 15/210.1; 15/218.1; 15/220.4; 15/229.11; 15/229.13; 15/244.1

(57) ABSTRACT

A blade cleaner having a protective holding apparatus is provided. A method for cleaning blades is also provided.

### INTRODUCTION

This application claims the benefit of U.S. Provisional Application No. 60/348,698, filed Jan. 15, 2002.

### FIELD OF THE INVENTION

This invention relates to a blade cleaner for cleaning and prolonging the life of blades used in paper and printing applications. Also related are methods of cleaning blades. Blades are the dominant means of applying inks and coatings to paper and packaging. The blade cleaners and methods of the present invention allow blades to be cleaned so that coating or ink buildup may be removed from the blade surfaces without injury to workers or machinery.

### BACKGROUND OF THE INVENTION

The paper or board manufactured for publication or packaging applications is frequently coated prior to printing. Desired properties such as opacity, gloss, smoothness and “printability” of a coated sheet are far improved over those of an uncoated sheet. Typically the coating is applied as a liquid mixture of clay, pigments, starch and/or other binders.

Coater blades are used for metering coatings and in particular waterborne calcium carbonate or clay based coatings on high grade paper used in the printing and packaging industry. Various types of coaters are used within the papermaking industry, but it is generally accepted that the highest quality coated paper surface is obtained using a blade coater. Printing doctor blades are used for metering ink in engraved cylinder used in printing. The coater blade scrapes or meters the amount of coat weight applied to the sheet, leaving a smooth, glossy surface. Any imperfection in or on the blade such as dried-on coating on its working edge will cause scratches and/or a non-uniform application of the coating. Therefore in order to maintain sheet quality, the coater blades on a paper machine must be changed out or cleaned at regular intervals.

Machinery failure and paper breaks necessitate line interruptions during which coating material can become dried onto the coating blades if the blades are not cleaned. It is common practice in the paper coating industry to simply dispose of blades that have dried coating or ink build up on them due to the high risk of injuries to the workers from blade cuts. Production losses are incurred due to the time needed to replace a blade and also because the operation of a new blade usually requires adjustment to ensure uniform coating and acquire distribution across the width of the machine. Therefore, the otherwise usable blades which are destroyed increase operating costs and manufacturing time.

Various tools exist for cleaning blades. U.S. Pat. No. 5,765,259 describes a blade cleaner which includes bristles with openings to allow vacuuming of dust from the blade surfaces. U.S. Patent 4,827,556 describes a ceiling fan blade cleaner including a fork and a separable cleaner. The fork has a tubular handle by which the user holds the device for cleaning purposes. The cleaner is formed of a fibrous web material and has a rectangular central portion.

U.S. Pat. No. 5,657,507 describes a windshield cleaning tool with a triangular cleaning member. The bottom of the cleaning member has a plurality of corrugations which may be transverse with respect to a center line. There may be a chamois like outer layer and a foam inner layer on the cleaning member. U.S. Pat. No. 6,029,575 describes a device for cleaning a cylinder in a printing press, having a cleaner engagable and disengagable with the cylinder.

In the present invention, a blade cleaner with a protective handle is provided which solves the problems of blade loss due to dried coatings and also prevents injuries to workers.

### SUMMARY OF THE INVENTION

An object of the present invention is to provide a blade cleaner comprising a base, a protective handle and a cleaning track.

Another object of the present invention is to provide a method of cleaning a blade using a blade cleaner comprising enclosing the blade in a cleaning track of the blade cleaner and moving the blade cleaner lengthwise across the blade.

Another object of the present invention is to provide a method of cleaning a blade using at least two blade cleaners comprising enclosing the blade in the cleaning track of a first blade cleaner wherein the first blade cleaner comprises an abrasive pad, and moving the first blade cleaner lengthwise across the blade using the protective handle, and then enclosing the blade in the cleaning track of a second blade cleaner wherein the second blade cleaner comprises a final cleaning pad, and moving the second blade cleaner lengthwise across the blade using the protective handle.

### BRIEF DESCRIPTION OF DRAWINGS

FIG. 1 shows a bottom view of a blade cleaner.

FIG. 2 shows a side view of a blade cleaner.

FIG. 3 shows a cross-sectional view of a blade cleaner.

### DETAILED DESCRIPTION OF THE INVENTION

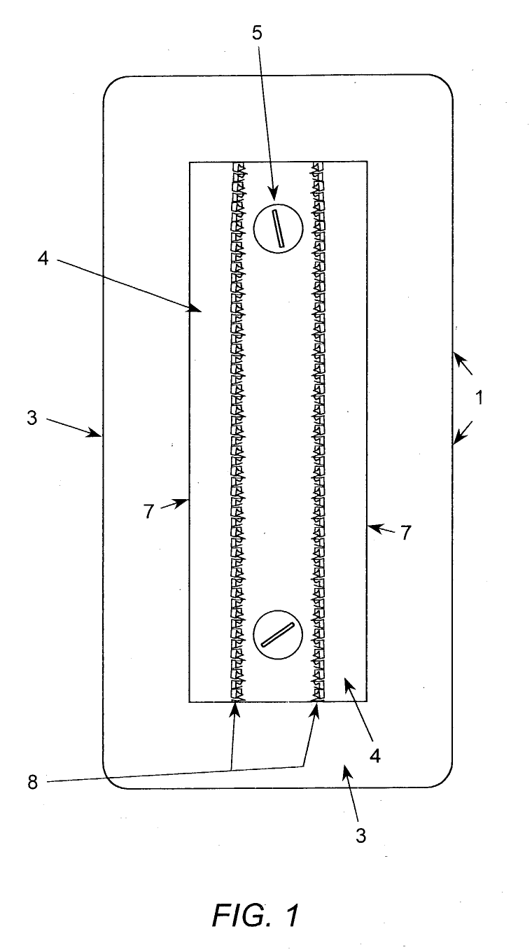

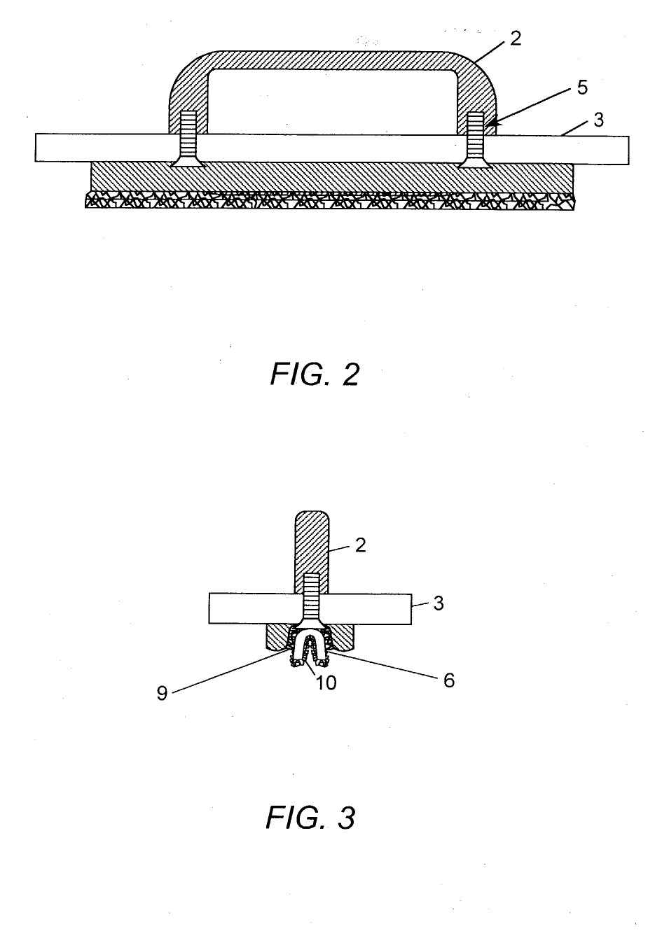

As shown in FIGS. 1, 2, and 3, the present invention is a blade cleaner useful for cleaning doctor, coater, or other various types of blades. The present invention is especially useful for blades common to the paper coating industry. The blade cleaner 1 is comprised of a protective handle 2 attached to the top side of a base 3. The base may be made of plastic, wood, metal or another suitable material. The bottom side of the base 3 is connected to a cleaning track 4 by at least one fastening mechanism 5. In a preferred embodiment the fastening mechanism is a screw, bolt, nut, or other fastener. The cleaning track 4 is preferably U-shaped, however other configurations may be utilized dependant upon the shape of the blade to be cleaned. The cleaning track holds cleaning pads 6 which may be of different textures and shapes dependant upon the exact nature of the cleaning to be accomplished by the cleaning pad 6. In a preferred embodiment, the cleaning pad 6 is of a coarse texture that allows for removal of dried coating or heavy residue from a blade without inducing deformities scratches or nicks into the blade, for example plastic or nylon scrubber pads, scouring pads, sand paper, Teflon or other scrubber or abrasive materials. In another preferred embodiment the cleaning pad 6 is soft or fine in texture and useful for removal of light residues, for example a sponge, foam or fabric. The cleaning pads may be used with water or another cleaning liquid or solution to aid in removal of coatings or inks for the blades.

The fastening mechanism 5 holds the cleaning track 4 adjacent to the bottom side of the base 3. The cleaning track 4 has an outer side 7 and an inner side 8. The inner side 8 of the cleaning track is formed in a shape of a channel such as a U-shape or V-shape or C-shape or other various configurations suitable to form a channel in which a blade can be inserted. The inside of the cleaning track forming the channel secures a cleaning pad 6 with an outer side 9 and an inner side 10. The cleaning pad may be folded in half so that a blade is sandwiched between the pad to clean two sides of a blade at one time. The cleaning pad 6 may be composed of one material or may be designed to comprise a combination of different fabrics or materials to clean a blade. The outside of the cleaning pad 6 is attached to the inner side of the cleaning track via a fastener. It is preferred that the fastener is made of a material that easily attaches to the cleaning pad such as a Velcro, hook and eye, snaps or other suitable fasteners. The fastener may comprise another suitable fastening material as would be known to one of skill in the art upon reading this disclosure.

The protective handle 2 is attached to the top side of a base 3 and may cover all or any portion of the base. In a preferred embodiment, the protective handle 2 is configured so that a human hand or other type of holder may contact the protective handle and exert force onto the handle in a manner so that the blade cleaner is moved in a lengthwise direction down the blade and the human hand or holder is free from contact with the cleaning pad and the cleaning blade. The protective handle may comprise a protective guard. The exact dimensions of the blade cleaner may be adjusted dependent upon the size and configuration of the blade to be cleaned. The blade cleaner may also be incorporated into an automated system which allows the blade cleaner to be moved down a blade electronically. The cleaning pad thickness may vary in thickness and in diameter and may extend varying lengths down the inner side of the cleaning track 4 forming a channel depending on the desired application. The length and width of the base 3 may vary to accommodate specific applications. In a preferred application the length of the base may vary from 10 inches to 14 inches depending upon the application. Preferably, the width of the base varies from 4 inches to 6 inches depending on the desired application. The length of the protective handle may also vary.

Also provided is a method of cleaning a blade using the blade cleaner comprising inserting the blade to be cleaned into a cleaning pad attached to the inner side of the cleaning track and applying force sufficient to move the blade cleaner lengthwise across the blade to remove coatings or materials present on the base. In a preferred embodiment the cleaning pad has been contacted or wet with water or another liquid prior to moving across the blade to aid in removal of dried coatings. The force which moves the blade cleaner down a blade is applied by using the protective handle on the blade cleaner.

Also provided is a method of cleaning a blade using at least two blade cleaners comprising inserting the blade to be cleaned into a first cleaning pad attached to the inner side of a first cleaning track of a first blade cleaner and applying force sufficient to move the first blade cleaner lengthwise across the blade to remove coatings or materials present on the blade, and then inserting the blade in a second blade cleaner wherein the second blade cleaner comprises a final cleaning pad, and moving the second blade cleaner lengthwise across the blade using the protective handle. Preferably the first cleaning pad is coarse in texture such a plastic or nylon scrubber pad, sandpaper, Teflon, or other suitable abrasives, and the final cleaning pad is non-abrasive and not coarse in nature such as a sponge, fabric or other non-abrasive materials. In a preferred embodiment the first cleaning pad and the second cleaning pad have been contacted or wetted with water or another liquid prior to moving across the blade to aid in removal of dried coatings.

The methods and blade cleaners of the present invention are particularly useful for cleaning doctor blades and coater blades.

As would be understood by one of skill in the art upon reading this disclosure, the dimensions of the blade cleaner, and the extent of blade coverage with the cleaning pads provided herein are merely exemplary and may be varied routinely by those of skill in the art depending upon the desired application.

What is claimed is:

1. A blade cleaner comprising a base, a protective handle and a cleaning track.

2. The blade cleaner of claim 1 wherein the protective handle comprises a protective guard.

3. The blade cleaner of claim 1 wherein the cleaning track holds an abrasive pad.

4. The blade cleaner of claim 1 wherein the cleaning track holds a final cleaning pad.

5. The blade cleaner of claim 1 wherein the cleaning track holds an abrasive pad and a final cleaning pad.

6. A method of cleaning a blade using the blade cleaner of claim 1 comprising enclosing the blade in the cleaning track of the blade cleaner and moving the blade cleaner lengthwise across the blade using the protective handle.

7. A method of cleaning a blade using at least two blade cleaners of claim 1 comprising enclosing the blade in the cleaning track of a first blade cleaner wherein the first blade cleaner comprises an abrasive pad, and moving the first blade cleaner lengthwise across the blade using the protective handle, and then enclosing the blade in the cleaning channel track of a second blade cleaner wherein the second blade cleaner comprises a final cleaning pad, and moving the second blade cleaner lengthwise across the blade using the protective handle.
